(19) United States
(12) Patent Application Publication
(10) Pub. No.: US 2011/0024959 A1
(43) Pub. Date: Feb. 3, 2011

(54) Double-acting buffer module

(75) Inventors: Wei-Lin Chang, Taichung City (TW); Chi-Pin Chou, Taichung City (TW)

Correspondence Address: CHARLES E. BAXLEY, ESQUIRE, 90 JOHN STREET, SUITE 403, NEW YORK, NY, 10038, US

(73) Assignee: Hiwin Mikrosystem Corp.

(21) Appl. No.: 12/462,319

(22) Filed: Jul. 31, 2009

(51) Int. Cl. F16F 1/06

(52) U.S. Cl. 267/137

(57) ABSTRACT

A double-acting buffer module includes a sliding member having a front end slidably receiving a pressing shaft and a rear end slidably received in an installing member. Therein, a first elastic member is provided between the pressing shaft and the sliding member while a second elastic member is provided between the sliding member and the installing member so that the pressing shaft and the sliding member perform a two-stage buffer movement in the installing member.

### BACKGROUND OF THE INVENTION

1. Technical Field

The present invention relates to buffer devices, and more particularly, to a buffer module featuring for its two-stage operation.

2. Description of Related Art

Conventionally, dampers are provided between moving parts and fixed parts in a machine to absorb mechanical impact therebetween and reduce damage or noise caused by such impact. However, these conventional dampers, which are typically buffers utilizing springs and hydraulic pressure, have their defects.

Particularly, springs are made with fixed coefficient of elasticity. A spring with low coefficient of elasticity is tender and thus gives less elastic strength when encountering impact, yet is inferior in affordability

Although a spring buffer with higher coefficient of elasticity has a significantly increased endurance, its higher rigidity renders a higher counterforce during impact. As a result, the kinetic energy can be partially offset only, and thus the resultant buffer effect is quite inadequate.

A known hydraulic buffer is very suitable for high-speed moving object because liquid has its coefficient of elasticity increasing with the amount of compression it performs and gives a relative low counterforce. However, in a vacuum environment or a clean room, the originally encapsulated liquid tends to gasify and leak out, thus causing oil vapour pollution, which is even more detrimental.

### SUMMARY OF THE INVENTION

In view of the defects of the prior art, one objective of the present invention is to provide a double-acting buffer module, wherein the double-acting buffer module performs a two-stage buffer movement. Upon impact, the double-acting buffer module performs a first stage buffer to provide a low counterforce, thereby protecting mechanism from being damaged. When the impact is huge, the double-acting buffer module performs a second stage buffer to provide a high resistance, thereby completely offsetting the impact energy.

A double-acting buffer module includes a sliding member having a front end slidably receiving a pressing shaft and a rear end slidably received in an installing member. Therein, a first elastic member is provided between the pressing shaft and the sliding member while a second elastic member is provided between the sliding member and the installing member so that the pressing shaft and the sliding member perform a two-stage buffer movement in the installing member.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a perspective view of a double-acting buffer module according to the present invention;

FIG. 2 is an exploded view of the double-acting buffer module according to the present invention;

FIG. 3 is a sectional view of the double-acting buffer module according to the present invention; and

FIGS. 4 and 5 are schematic drawings illustrating operation of the double-acting buffer module according to the present invention.

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale.

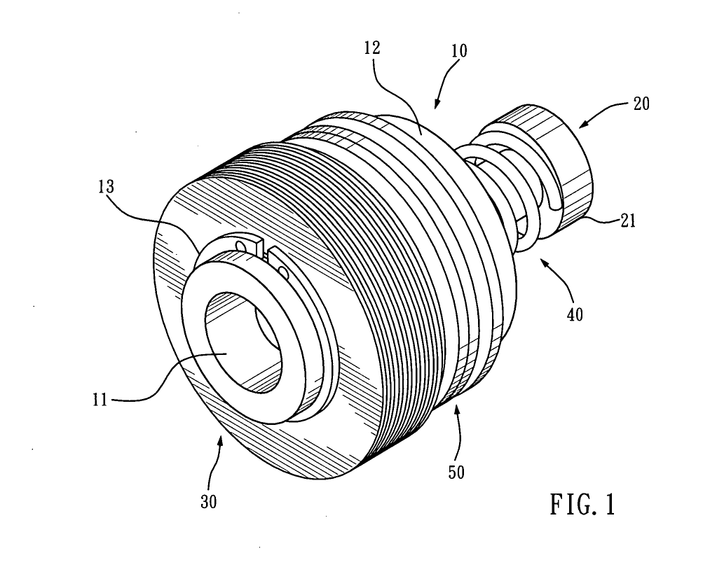

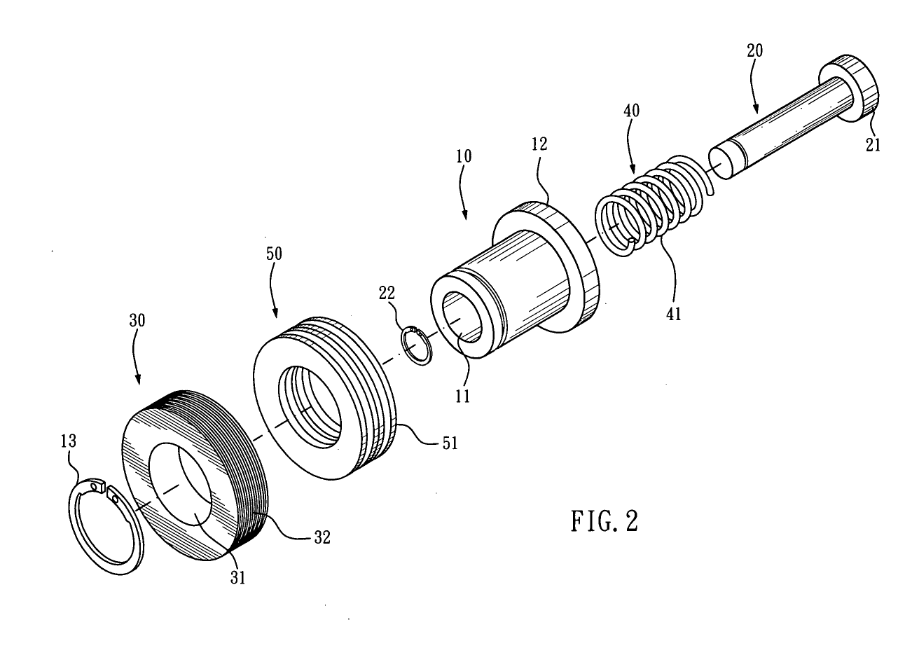

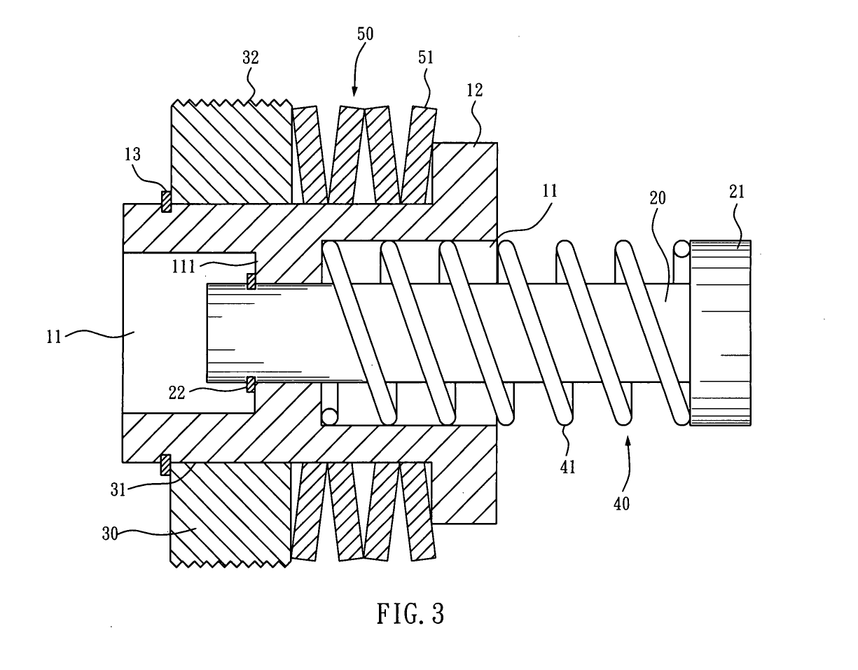

Please refer to FIGS. 1 through 3 for a double-acting buffer module according to the present invention. The double-acting buffer module includes a sliding member 10, a pressing shaft 20, an installing member 30, a first elastic member 40, and a second elastic member 50.

The sliding member 10 is centrally formed with a through hole 11 including an inward extended annular rib 111. Therein a retaining flange 12 is extended outward at a front end of the sliding member 10.

The pressing shaft 20 is a column and has a front end formed as a diametrically enlarged impacting end 21. The pressing shaft 20 slidably passes through the front end of the sliding member 10, the through hole 11, and the rib 111. Therein the impacting end 21 has a diameter equal to or slightly smaller than that of the through hole 11 and greater than that of a hole defined by the rib 111. In addition, a retaining ring 22 is inlaid on the pressing shaft 20 at an end opposite to the impacting end 21, so as to limit the travel of the pressing shaft 20 together with the rib 111.

The installing member 30 is structurally a circular body containing therein a hole 31 for slidably receiving the sliding member 10. Therein, a threaded segment 32 is provided at an outer periphery of the installing member 30. A fixing ring 13 is inlaid on the sliding member 10 at an end opposite to the retaining flange 12, so as to limit the travel of the sliding member 10 together with the sliding member 30.

The first elastic member 40 is herein a compression spring 41 mounted around the pressing shaft 20 with two ends thereof abutting against the rib 111 and the impacting end 21, respectively.

The second elastic member 50 is herein an assembly of plural disk springs 51 mounted around the sliding member 10 with two ends thereof abutting against the installing member 30 and the retaining flange 12, respectively.

The installing member 30, in virtue of the threaded segment 32, serves to fix the double-acting buffer module of the present invention at a predetermined location. The pressing shaft 20, in virtue of the first elastic member 40, serves to allow the pressing shaft 20 to slide back and forth inside the sliding member 10. The sliding member 10, in virtue of the second elastic member 50, serves to slide back and forth inside the installing member 30. Since the impacting end 21 of the pressing shaft 20 juts out of the installing member 30 and the sliding member 10, when high-speed mechanical impact happens, the impacting end 21 is the first to be compressed, and the first elastic member 40 thus realizes the first buffer stage.

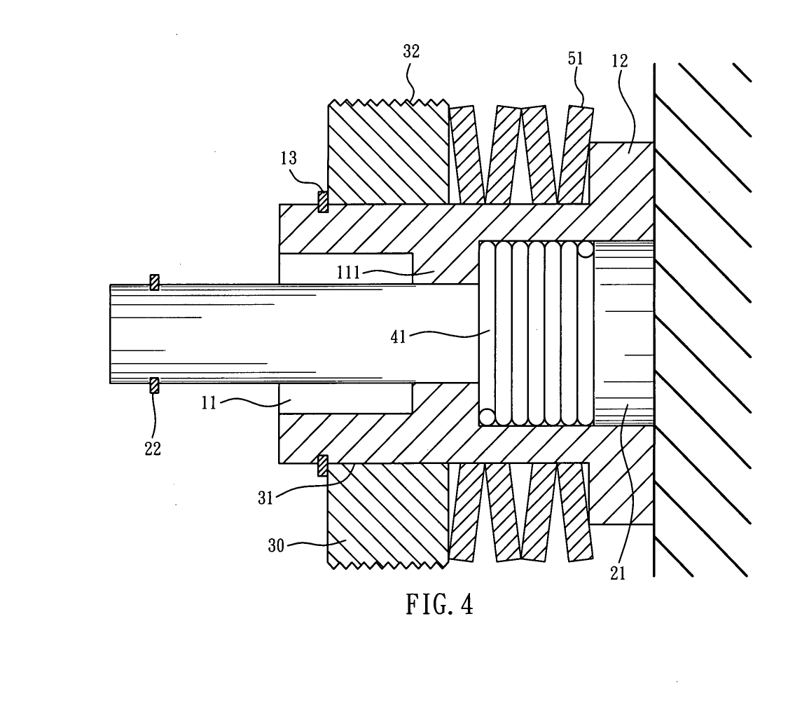

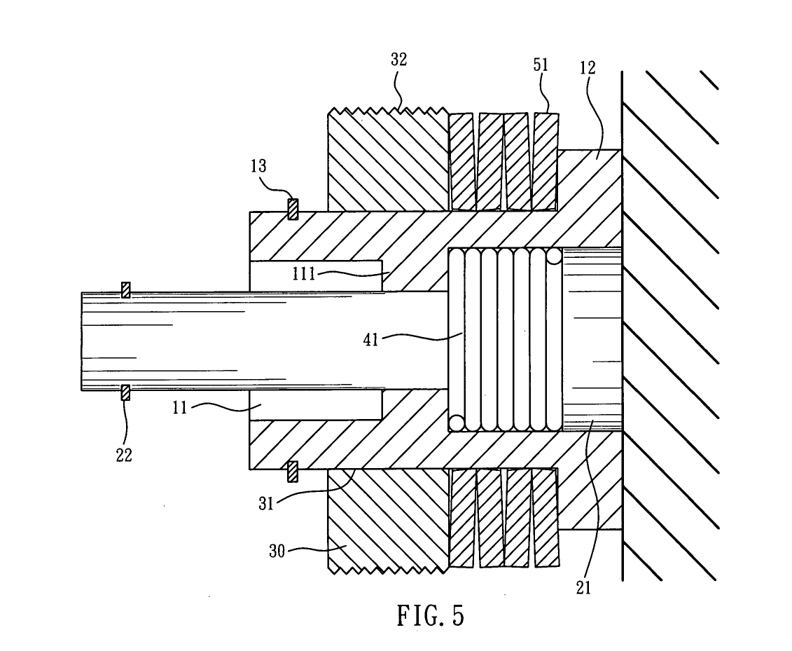

Referring to FIG. 4, when the pressing shaft 20 continuously receives the force and gets compressed until the impacting end 21 is completely received in the through hole 11, the retaining flange 12 comes to contact the surface of the impacting mater, so that the second elastic member 50 is compressed and thus realizes the second buffer stage.

Therein, the first elastic member 40 is the compression spring 41 that has a relatively low coefficient of elasticity while the second elastic member 50 is the assembly of the disk spring 51 that has a relatively high coefficient of elasticity. During the first stage buffer, the compression spring 41 having the lower elasticity coefficient serves to dispatch the impact energy, so that the counterforce between the pressing shaft 20 and the impacting matter can be minimized, thereby protecting the mechanism from being damaged. During the second stage buffer, the assembly of the disk springs 51 having the higher elasticity coefficient serves to absorb the remained impact energy, so as to completely absorb the impact energy of the high-speed impact and reliably provide buffer effect.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A double-acting buffer module, comprising:
a sliding member having a front end slidably receiving a pressing shaft and a rear end slidably received in an installing member;
wherein a first elastic member is provided between the pressing shaft and the sliding member while a second elastic member is provided between the sliding member and the installing member so that the pressing shaft and the sliding member perform a two-stage buffer movement in the installing member.

2. The double-acting buffer module of claim 1, wherein the sliding member is centrally formed with a through hole including an inward extended annular rib for allowing the pressing shaft to pass therethrough.

3. The double-acting buffer module of claim 2, wherein the pressing shaft has a front end formed as a diametrically enlarged impacting end.

4. The double-acting buffer module of claim 3, wherein the first elastic member is a compression spring mounted around the pressing shaft with two ends thereof abutting against the rib and the impacting end, respectively.

5. The double-acting buffer module of claim 4, wherein a retaining ring is inlaid on the pressing shaft at an end opposite to the impacting end, so as to limit the travel of the pressing shaft together with the rib.

6. The double-acting buffer module of claim 1, wherein the installing member is a circular body containing therein a hole for slidably receiving the sliding member.

7. The double-acting buffer module of claim 6, wherein a retaining flange is extended outward at a front end of the sliding member.

8. The double-acting buffer module of claim 7, wherein the second elastic member is mounted around the sliding member with two ends thereof abutting against the installing member and the retaining flange, respectively.

9. The double-acting buffer module of claim 8, wherein the second elastic member is composed of a plurality of disk springs.

10. The double-acting buffer module of claim 8, wherein a fixing ring is inlaid on the sliding member at an end opposite to the retaining flange, so as to limit the travel of the sliding member together with the sliding member.

11. The double-acting buffer module of claim 1, wherein a threaded segment is provided at an outer periphery of the installing member.
